(19) United States
(12) Patent Application Publication
(10) Pub. No.: US 2009/0138297 A1
(43) Pub. Date: May 28, 2009

(54) ELECTRONIC SYSTEMS AND METHODS TO FACILITATE CONSTRUCTIVE ASSOCIATIONS BETWEEN VENDORS AND CUSTOMERS

(76) Inventor: Earl T. LeBlanc, JR., Baton Rouge, LA (US)

Correspondence Address: BUCHALTER NEMER, 18400 VON KARMAN AVE., SUITE 800, IRVINE, CA, 92612, US

(21) Appl. No.: 11/945,451

(22) Filed: Nov. 27, 2007

(51) Int. Cl. G06Q 10/00

(52) U.S. Cl. 705/7

(57) ABSTRACT

Electronic systems for facilitating a vendor-customer association are described herein where contemplated systems comprise: a computer comprising a processor, an executable code, wherein the code is accessed and run on the processor and wherein the code comprises: an information-gathering function that processes information about the vendor and the customer, a security function that creates a unique identifier assigned to the vendor, customer or combination thereof and creates a profile for the vendor, customer or combination thereof, a sorting function, wherein the sorting function reviews the profile of the customer and the vendor, and a contact function, wherein the contact function contacts the vendor, customer or combination thereof depending on a set of contact settings for that individual or business vendor, customer or combination thereof.

### FIELD OF THE SUBJECT MATER

The field of the subject matter is electronic systems and methods that facilitate constructive and desirable associations and relationships between vendors and customers.

### BACKGROUND

In the sales profession, cold calling is one of the most widely used methods to reach potential customers and to maximize business. “Cold Calling” is basically the process whereby a salesperson drives around in a given geographical area, stops by different companies (w/o obtaining an appointment first), walks in, introduces him/her self, and then tries to present his/her product to someone that may or may not be interested in purchasing the product.

The biggest downside to “cold calling” is that it is hated by most businesses and can prove to be quite difficult, uncomfortable, or even sometimes, impossible for both the salesperson and the business purchasing representatives. Some businesses are accessible to salespeople who cold call and others are not.

For those businesses that are open to cold callers, the salesperson usually enters the company's office and begins talking to the receptionist or another employee to explain why he/she is there and what product he/she has to offer. The employee then either immediately tells the salesperson that the company is not interested, may pass him/her off to the company's purchasing department, or may call a superior that has to listen to the presentation all over again to make the decision if the product is needed. One way or the other, this process can (and often does) waste up to three people's time with each salesperson that comes through the door. Multiply this process by ten salespeople a week and this can cost the company an extraordinary amount of productivity (and money).

For those businesses that are not open to cold callers, these companies usually have a “NO SOLICITING” sign posted on the front door, and frankly, this policy simply does not work, since salespeople are generally trained to ignore these types of signs and will walk in to introduce themselves and explain their product anyway. This process still wastes the receptionist's time and can prove to make for an uncomfortable situation for the receptionist. In addition, if the receptionist is trained well enough to immediately turn away the salesperson, the company may actually lose out since that salesperson may have a product or service that the company actually needs.

The solution to this problem may lie in the effective use of current technology to put savvy salespeople together with willing businesses in order to promote and purchase useful goods and services. U.S. Pat. No. 7,249,066 attempts to solve this problem by providing a system where a salesperson can offer goods and services to a business through the Internet. The system works by requiring that the salesperson contact a business for an E-mail address. The salesperson then uses the system on the Internet to send a presentation link to the business through that E-mail address. The business then clicks on the link to review the salesperson's goods and services. However, there is no security function that determines whether the salesperson and the business are a good match for goods and services. In addition, the salesperson still has to speak to someone at the business, by phone or in person, to get the E-mail address.

Therefore, it would be ideal to facilitate useful vendor/customer relationships by a) utilizing current technology to put salespeople together with willing purchasers, b) linking product or service vendors with customers who are looking specifically for those products or services, c) giving vendors and customers the ability to connect with one another during appropriate times and in appropriate places, and d) securely promoting useful vendor/customer relationships, while at the same time eliminating extraneous communications from other undesirable vendors. One way or the other, for any of these companies, the current methods of handling cold callers are generally a waste of time and money.

### SUMMARY OF THE SUBJECT MATTER

Electronic systems for facilitating a vendor-customer association are described herein where contemplated systems comprise: a computer comprising a processor, an executable code, wherein the code is accessed and run on the processor and wherein the code comprises: an information-gathering function that processes information about the vendor and the customer, a security function that creates a unique identifier assigned to the vendor, customer or combination thereof and creates a profile for the vendor, customer or combination thereof, a sorting function, wherein the sorting function reviews the profile of the customer and the vendor, and a contact function, wherein the contact function contacts the vendor, customer or combination thereof depending on a set of contact settings for that individual or business vendor, customer or combination thereof.

Methods for facilitating a vendor-customer association are described herein where contemplated methods comprise: providing a computer comprising a processor, providing an executable code, and accessing and running the code on the processor, wherein the code comprises: an information-gathering function that processes information about the vendor and the customer, a security function that creates a unique identifier assigned to the vendor, customer or combination thereof and creates a profile for the vendor, customer or combination thereof, a sorting function wherein the sorting function reviews the profile of the customer and the vendor, and a contact function, wherein the contact function contacts the vendor, customer or combination thereof depending on a set of contact settings for that individual or business vendor, customer or combination thereof.

### BRIEF DESCRIPTION OF THE FIGURES

FIG. 1 shows a contemplated system to facilitate constructive relationships between vendors and customers.

FIG. 2 shows a contemplated method to facilitate constructive relationships between vendors and customers.

### DETAILED DESCRIPTION

Surprisingly, electronic systems and methods have been developed and are herein disclosed that promote useful vendor/customer relationships by a) utilizing current technology to put salespeople together with willing purchasers, b) linking product or service vendors with customers who are looking specifically for those products or services, c) giving vendors and customers the ability to connect with one another during appropriate times and in appropriate places, and d) securely promoting useful vendor/customer relationships, while at the same time eliminating extraneous communications from other undesirable vendors, potential vendors or salespersons.

An electronic system contemplated herein comprises: a) a server, b) an executable software code and/or program that is designed to operate on the server, c) an interface, wherein a user can access the software program. Contemplated software programs are designed to securely and efficiently bring together vendors and customers. These software programs comprise: a) an information-gathering function, b) a security function, c) a sorting function and d) a contact function.

Specifically, electronic systems for facilitating a vendor-customer association are described herein where contemplated systems comprise: a computer comprising a processor; an executable code, wherein the code is accessed and run on the processor and wherein the code comprises: an information-gathering function that processes information about the vendor and the customer, a security function that creates a unique identifier assigned to the vendor, customer or combination thereof and creates a profile for the vendor, customer or combination thereof, a sorting function, wherein the sorting function reviews the profile of the customer and the vendor, and a contact function, wherein the contact function contacts the vendor, customer or combination thereof depending on a set of contact settings for that individual or business vendor, customer or combination thereof.

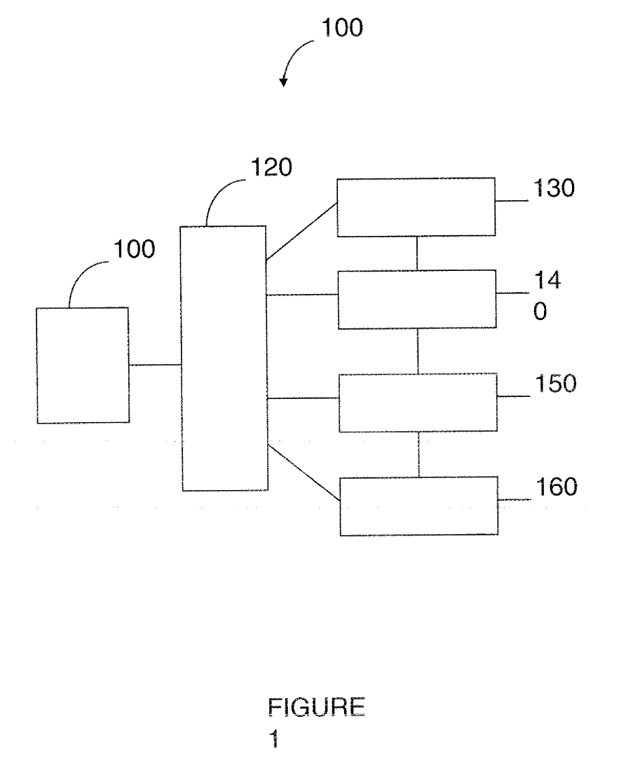

A contemplated system 100 is shown in FIG. 1, where a computer 110 has a processor (not shown), wherein an executable code 120 is accessed and run on the processor and wherein the code 120 comprises an information-gathering function 130 that processes information about the vendor and the customer, a security function 140 that creates a unique identifier assigned to the vendor, customer or combination thereof and creates a profile for the vendor, customer or combination thereof, a sorting function 150, wherein the sorting function reviews the profile of the customer and the vendor, and a contact function 160, wherein the contact function contacts the vendor, customer or combination thereof depending on a set of contact settings for that individual or business vendor, customer or combination thereof.

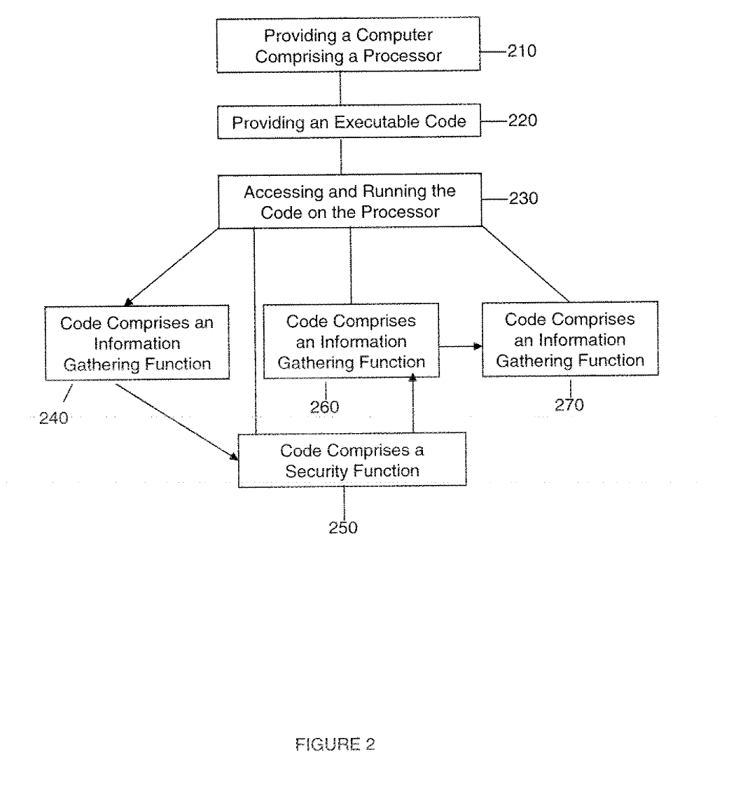

Methods for facilitating a vendor-customer association 200 are described herein and shown in FIG. 2 where contemplated methods comprise: providing a computer comprising a processor 210, providing an executable code 220, and accessing and running the code on the processor 230, wherein the code comprises: an information-gathering function that processes information about the vendor and the customer 240, a security function 250 that creates a unique identifier assigned to the vendor, customer or combination thereof and creates a profile for the vendor, customer or combination thereof, a sorting function 260, wherein the sorting function reviews the profile of the customer and the vendor, and a contact function 270, wherein the contact function contacts the vendor, customer or combination thereof depending on a set of contact settings for that individual or business vendor, customer or combination thereof.

In contemplated executable codes and software programs, the information-gathering function is designed as it sounds—to gather useful and necessary information from the potential vendors and willing customers. Useful and necessary information includes contact information, such as name, address, phone, fax, E-mail, best time to contact, best way to contact and who to contact, type of business, customer needs with respect to goods and services, vendors wares, pricing policies and schedules, and other information that would be necessary to efficiently put together vendors with customers.

Once the information-gathering function is completed, a security function is initiated that comprises at least two steps: creating a unique identifier assigned to the vendor or customer and creating a profile for the vendor and/or customer. The unique identifier is usually a number or combination of numbers, letters and symbols that the user displays for the purposes of initiating a connection between vendors and customers. For example, a potential customer may put a sign on its door, website or company literature that lists the unique identifier and the interactive software location, such as a website. A salesperson, in the process of identifying potential customers would see this unique identifier and realize that in order to connect in a meaningful way with the customer, he/she should go to the software location and enter the customer's unique identifier. The unique identifier is then linked to the profile for the vendor and the potential customer, and if the potential customer has products and/or services needs that match the vendor, a connection is facilitated through the sorting function.

Once the security function is initiated, the sorting function comes into play. A contemplated sorting function is designed to be similar to a mail sorter. When a potential customer or vendor enters a unique identifier, the sorting function reviews the profile of the potential customer and the vendor to determine if there is a match between the needs and the goods/services.

The sorting function can be based on a number of parameters either set by business standards or set by the company/individual itself. For example. SIC (or NAIC) codes indicate what business segment that a certain company serves. These codes could be used in a company's profile to indicate what type of salespeople it either does or doesn't want to meet. An established and large computer chip manufacturing company may get 100 salespeople calling on them in a weeks time. Obviously, they would not want to hear from any salesperson who has office furniture (SIC code 2521) for sale. The service could be set up where the company refuses to hear any presentations from salespeople with this SIC code. This would automatically “weed out” several salespeople and save the decision maker some additional time. Alternatively, a small and new company that rebuilds valves may only get ten salespeople in a week, so they may not want the SIC/NAIC sorting function. This smaller company may want all presentations sent directly to the company decision maker—who sorts out and responds to the presentations on his/her own. If there is a match between the needs and the goods/services, then the contact function is initiated.

Contemplated contact functions are designed to contact the vendor and/or potential customer depending on the contact settings for that individual or business. For example, if a potential customer has selected in the customer profile to only be contact via E-mail, then the contact function will send an E-mail introducing the vendor to the customer's E-mail address. This process will allow the customer to review the E-mail at a convenient time and contact the vendor as needed or desired.

Contemplated electronic systems, as mentioned earlier, are designed to store, route and monitor contemplated software systems described herein, so that vendors and/or potential customers can utilize the software system on a local computer, a to network computer, a handheld device, a cell phone or any other two-way communication device through an interface, such as a monitor, screen and/or speakers. The software program can be accessed and utilized from the server or may be downloaded onto a user's computer to be used locally.

### EXAMPLES

A company signs up for the service and is given a sign with a unique identifier, such as a badge number. The sign has the following message:

The company posts the sign on all doors, fences, etc, where salespeople could possibly enter and all employees should be trained to refer to the signs if a salesperson should ignore them. In addition, the company lists the badge number on the company website and possibly company advertising materials.

Once salespeople begin to understand that there is no other way that they can present their product to this company, they will then go to the above mentioned website to investigate—that is, if it is indeed important enough for them to present their product to that particular company. If not, then the salesperson will go away and the company will never see that product. The company will save time and money by not having to listen to a sales pitch for a product that is useless to them.

If a salesperson wants to introduce his/her product to the company, then that person will go to the website, where it will need to register and possibly pay a one-time fee or monthly/annual membership fee, so that an email presentation (250 words or less) can be made to the company.

Once the salesperson or vendor completes the registration process, the salesperson will compose their presentation through the website and click on the “Send” button. The presentation will then be routed (via email) to a designated person at the company. That person will then evaluate if it is a product that they want to see more information on and can contact the salesperson. This process can be made extremely easy and time-efficient because they will have a drop down menu with the following options:
1. I'm sorry but this company has no use for your product
2. We may have a use for your product but cannot make appointments at this time. Please contact me in 2 weeks at the following phone number
3. Your product sounds interesting. Can you please send me some literature to the following address?
4. We definitely have use for your product, please call us back immediately at phone number

### Benefits of the System to Companies:

1. Salespeople never enter the office to disturb workers from their jobs—money is saved every day because there is no loss of productivity.
2. If the company has a large yard with much activity, all salespeople are stopped at the gate—potential lawsuits are avoided by keeping non-employees away from dangerous areas.
3. If a company currently has a “NO SOLICITING” policy, they are not being made aware of new products in the marketplace that could save them money—this system can change that situation.
4. If an over aggressive salesperson keeps emailing the company, they can be blocked as spam. This is much easier on employees rather than turning them away at the door.
5. Every year the company will be required to update its information, including possibly paying a membership fee or subscription fee. With this update, they will be given a new badge number for their sign. With badge numbers of companies changing on a regular basis, this will prevent anyone from collecting company badge numbers in an effort to sell them or to list them on the internet for others to utilize. Basically, if a salesperson wants to continually try and sell his product to a company that doesn't want his/her product, that salesperson will physically have to drive to the company location to get a new badge number each year.

### Benefits of the System to Salespeople:

1. Sales presentations (and valuable time) are not wasted on non-decision makers. The person at the company who evaluates presentations received through the system and schedules appointments will know enough to accurately determine if the product is worthwhile for the company or not.
2. Once one sales presentation is made to one company in the system, the same data can be presented to other companies in the network by simply “cutting and pasting”, which saves time.
3. Salespeople can now make presentations to companies that were previously completely cut off from them. For instance, chemical plants are typically difficult places for new salespeople to present their product since there is nothing there physically except fences and a guard shack. They will now also be sure that their presentation goes to the right person.
4. Salespeople often are forced to leave literature at the front desk, front gate, or guard shack since they do not have any communication with the “decision makers.” Often times this literature is wasted and ends up getting thrown out. With this system, literature is only transmitted to decision makers—and on request, which can save money.
5. Sometimes sales people get tired and may not remember all the benefits of their product when talking initially with a prospective customer. With a well written presentation, they will always have a consistent presentation to all companies.
6. “Cold Calling” will basically be made a thing of the past. While salespeople will still have to physically drive to a place of business to obtain a company's badge number, they will never have to feel uncomfortable by walking into an unknown office environment. After a presentation is made through the system and the company has asked for an appointment, the salesperson just strictly has to follow through. Appointments are always better for both salespeople and the company as well.
6. After dropping off literature, salespeople usually try to get a contact name so they can follow up with that person. Often times, that salesperson will make several phone calls and several trips to the business and still never really know if he or she is chasing after the right person or not. Every time a salesperson uses this system, they will get a response from the company. They will immediately know if they should cross the company off of their prospect list or not.
7. Registration and membership fees are a small investment of time and money for a salesperson—especially if it prevents them from continually calling or stopping by a certain company.

Thus, specific embodiments and applications of electronic systems and methods of facilitating associations between vendors and customers have been disclosed. It should be apparent, however, to those skilled in the art that many more modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

I claim:

1. An electronic system for facilitating a vendor-customer association, the system comprising:
a computer comprising a processor, and
an executable code, wherein the code is accessed and run on the processor and wherein the code comprises:
an information-gathering function that processes a plurality of information about the vendor and the customer,
a security function that creates a unique identifier assigned to the vendor, customer or combination thereof and creates a profile for the vendor, customer or combination thereof,
a sorting function, wherein the sorting function reviews the profile of the customer and the vendor, and
a contact function wherein the contact function contacts the vendor; customer or combination thereof depending on a set of contact settings for that individual or business vendor, customer or combination thereof.

2. The electronic system of claim 1, wherein the executable code is located on a network server.

3. The electronic system of claim 1, wherein the executable code is accessed via the Internet.

4. The electronic system of claim 1, wherein the information about the vendor and the customer comprises name, address, phone, tax, E-mail, best time to contact, best way to contact and who to contact, type of business, customer needs with respect to goods and services, vendors wares pricing policies and schedules, other information that would be necessary to efficiently put together vendors with customers and combinations thereof.

5. The electronic system of claim 1, wherein the security function comprises at least two steps.

6. The electronic system of claim 5, wherein the at least two steps comprises creating a unique identifier assigned to the vendor or customer, creating a profile for the vendor or customer, creating a profile for the vendor and customer or a combination thereof.

7. The electronic system of claim 6, wherein the unique identifier comprises at least one number, letter, symbol or combination thereof.

8. The electronic system of claim 1, wherein the sorting function reviews the profile of the potential customer and the vendor to determine if there is a match between the needs and the goods or services.

9. The electronic system of claim 1, wherein the computer comprises a local computer, a network computer, a handheld device, a cell phone or any other two-way communication device.

10. The electronic system of claim 1, wherein the computer comprises a user interface.

11. The electronic system of claim 10, wherein the user interface comprises a monitor, a key board, a speech-recognition device, a screen, at least one speaker or a combination thereof.

12. A method for facilitating a vendor-customer association, the method comprising:
providing a computer comprising a processor,
providing an executable code, and
accessing and running the code on the processor and wherein the code comprises:
an information-gathering function that processes information about the vendor and the customer,
a security function that creates a unique identifier assigned to the vendor, customer or combination thereof and creates a profile for the vendor, customer or combination thereof,
a sorting function, wherein the sorting function reviews the profile of the customer and the vendor, and
a contact function, wherein the contact function contacts the vendor, customer or combination thereof depending on a set of contact settings for that individual or business vendor, customer or combination thereof.

13. The method of claim 12, wherein the executable code is located on a network server.

14. The method of claim 12, wherein the executable code is accessed via the Internet.

15. The method of claim 12, wherein the information about the vendor and the customer comprises name, address, phone, tax, E-mail, best time to contact, best way to contact and who to contact, type of business, customer needs with respect to goods and services, vendors wares, pricing policies and schedules, other information that would be necessary to efficiently put together vendors with customers and combinations thereof.

16. The method of claim 12, wherein the security function comprises at least two steps.

17. The method of claim 16, wherein the at least two steps comprises creating a unique identifier assigned to the vendor or customer, creating a profile for the vendor or customer, creating a profile for the vendor and customer or a combination thereof.

18. The method of claim 17, wherein the unique identifier comprises at least one number, letter, symbol or combination thereof.

19. The method of claim 12, wherein the sorting function reviews the profile of the potential customer and the vendor to determine if there is a match between the needs and the goods or services.

20. The method of claim 12, wherein the computer comprises a local computer, a network computer, a handheld device, a cell phone or any other two-way communication device.
